(19) United States
(12) Patent Application Publication
(10) Pub. No.: US 2018/0209249 A1
(43) Pub. Date: Jul. 26, 2018

(54) Well Placement Plan Optimization

(71) Applicant: Schlumberger Technology Corporation, Sugar Land, TX (US)

(72) Inventors: Aleksandr Bogush, Didcot (GB); Peter Tilke, Watertown, MA (US); Barys Andreevich Samson, Oxforsdhire (GB)

(21) Appl. No.: 15/745,435

(22) PCT Filed: Jul. 20, 2016
(86) PCT No.: PCT/US2016/043043

§ 371 Date: Jan. 17, 2018

Related U.S. Application Data
(60) Provisional application No. 62/194,865, filed on Jul. 21, 2015.

(51) Int. Cl. E21B 41/00; G06Q 10/06; G06Q 10/10; G06Q 50/02

(52) U.S. Cl. CPC E21B 41/0092; G06Q 10/067; E21B 49/00; G06Q 10/103; G06Q 50/02; G06Q 10/06395

(57) ABSTRACT

A well placement plan optimization (300) which considers existing wells and heterogeneity constraints in a consolidated manner, rather than relying on individual decisions where to place the next producer (P1-P4), injector I1), or recomplete an existing producer as injector. These individual decisions are combined in a whole field optimization process, in order to discover a plan that maximizes an objective function such as net present value or recovery.

### CROSS-REFERENCE TO RELATED APPLICATION

The present document is based on and claims priority to U.S. Provisional Application Ser. No. 62/194865, filed Jul. 21, 2015, which is incorporated herein by reference in its entirety.

### TECHNICAL FIELD

This application generally relates to oil exploration, and specifically to the placement of wells in greenfields and brownfields.

### BACKGROUND OF THE INVENTION

Determining the optimal well placement plan during field development is a crucial step in the exploration and production workflow. There are multiple types of constraints that influence where well can be efficiently placed, for example geometrical, geological, operational, legal, etc.

Many mature brownfields now perform sub-optimally due to changes in the dynamic reservoir properties (saturation, pressure, etc) over decades of production. These reservoirs are therefore not only heterogeneous with respect to their static properties (porosity, permeability, etc.), but are also heterogeneous with respect to these dynamic properties. This heterogeneity limits applicability of classical pattern-based well placement planning and only allows for local improvements such as infill drilling, recompletions, etc.

It is known in the literature (Tilke at el., “High-speed Field Development Planning in the Presence of Uncertainty and Risk Through the Use of Constrained Numerical Optimization and Analytical Simulation”, SPE-164793, 2013], to generate a geometrical pattern, e.g. 5-spot from 5 variables, and use those as control variables in, for example, a linear downhill simplex optimization method (e.g., the Nelder-Mead method). See, e.g., FIG. 1 for an illustration.

It is an object of this invention to provide a robust approach for well placement plan optimization which considers existing wells and streamlines in a brownfield, and further provides optimized planning for greenfields.

### SUMMARY OF THE INVENTION

The present invention addresses this object by providing a robust approach for well placement plan optimization, which considers existing wells and heterogeneity constraints. According to principles of the present invention, rather than relying on individual decisions where to place the next producer, injector, or recomplete an existing producer as injector, a consolidated approach is used, wherein all these individual decisions are combined in a whole field optimization process, in order to discover the plan that maximizes an objective function such as NPV or recovery.

### BRIEF DESCRIPTION OF THE DRAWINGS

The present disclosure will be more readily understood from a detailed description of some example embodiments taken in conjunction with the following figures:

FIG. 1 illustrates a pattern control vector for a 5-spot pattern, showing the location of one well (x,y), the well spacing, azimuth and aspect ratio. These five control variables are sufficient to define the geometry of a pattern.

FIG. 2 is an illustration of an exemplary computing environment in which the principles of the present invention may be applied.

FIG. 3 is a flow diagram illustrating a streamline calculation performed by the computing system of FIG. 2 consistent with principles of the present invention.

FIG. 4 is an illustration of distortion applied to a single 5-spot pattern and the resulting movements of other wells to maintain the center of mass.

FIG. 5 is a visualization of streamlines showing the combination of existing and proposed new wells and allocation factors and streamlines for a particular timestamp.

FIG. 6 is a visualization similar to that seen in FIG. 5, showing water saturation at the start of the prediction.

### DETAILED DESCRIPTION

Various non-limiting embodiments of the present disclosure will now be described to provide an overall understanding of the principles of the structure, function, and use of the well placement systems and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

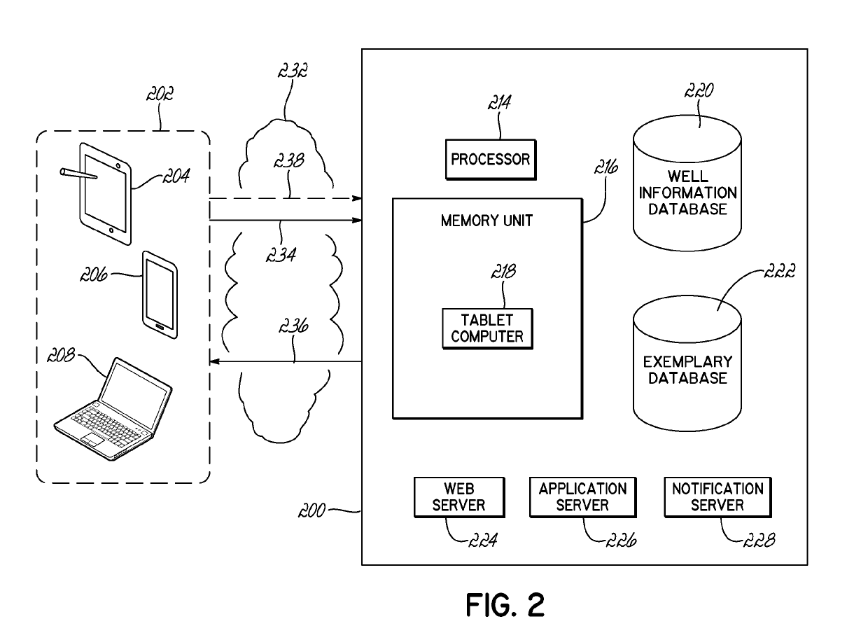

Referring now to FIG. 2, one example embodiment of the present disclosure may comprise a well placement management system 200 that receives and processes information relating to existing wells and develops a plan for additional wells. The well placement system 200 may then determine which content to provide to users and then provide the content to remote and/or portable computing devices associated with the users. The well placement system 200 may be provided using any suitable processor-based device or system, such as a personal computer, laptop, server, mainframe, or a collection (e.g., network) of multiple computers, for example. The well placement system 200 may include one or more processors 214 and one or more computer memory units 216. For convenience, only one processor 214 and only one memory unit 216 are shown in FIG. 2. The processor 214 may execute software instructions stored on the memory unit 216. The processor 214 may be implemented as an integrated circuit (IC) having one or multiple cores. The memory unit 216 may include volatile and/or non-volatile memory units. Volatile memory units may include random access memory (RAM), for example. Non-volatile memory units may include read only memory (ROM), for example, as well as mechanical non-volatile memory systems, such as, for example, a hard disk drive, an optical disk drive, etc. The RAM and/or ROM memory units may be implemented as discrete memory ICs, for example.

The memory unit 216 may store executable software and data for well placement engine 218. When the processor 214 of the well placement system 200 executes the software of the well placement engine 218, the processor 214 may be caused to perform the various operations of the well placement system 200. Operations may include, without limitation, receiving data of an existing well from a portable communication device 202, receiving queries from a user relating to an existing well or a well placement plan from a portable communication device 202 (such as in the form of a web page retrieval 234 or application programming interface (API) data retrieval 238, for example), generate a well placement strategy, potentially receive and analyze supplemental information received from a portable communication device 202, and send responses 236 to a portable communication device 202 via a wired and/or wireless communication network.

Data used by the well placement engine 218 may be from various sources, such as a well information database 220, which may be an electronic computer database, for example. The data stored in the database 220 may be stored in a non-volatile computer memory, such as a hard disk drive, a read only memory (e.g., a ROM IC), or other types of non-volatile memory. Also, the data of the database 220 may be stored on a remote electronic computer system, for example. The data in the database 220 may be, without limitation, data tables, video content, audio content, text-based content, and so forth. The pieces of content in the database 220 may be tied to a particular coded identifier, for example. In some embodiments, a user or other information provider may use a web portal, application program interface (API), or other form of interface to provide and manage content of the well placement system 200.

Additional databases, illustrated by the exemplary database 222, which may be an electronic computer database, for example, may also be used by the well placement engine 218. The data stored in the additional database(s) 222 may be stored in a non-volatile computer memory, such as a hard disk drive, a read only memory (e.g., a ROM IC), or other types of non-volatile memory. Also, the data of the additional database(s) 222 may be stored on a remote electronic computer system, for example. Data stored in the database(s) 222 may include information regarding particular users of the well placement system 200, such as login information, user preferences, and so forth.

The well placement system 200 may be in communication with portable multifunction devices 202 via an electronic communications network 232. The communications network may include a number of computer and/or data networks, including the Internet, LANs, WANs, GPRS networks, etc., and may comprise wired and/or wireless communication links. The portable multifunction devices 202 that communicate with the well placement system 200 may be any type of client device suitable for communication over the network, such as a personal computer, a laptop computer, or a netbook computer, for example. In some example embodiments, a user may communicate with the network via a portable multifunction device 202 that is a combination handheld computer and mobile telephone, sometimes referred to as a smart phone or tablet. It can be appreciated that while certain embodiments may be described with users communication via a smart phone or laptop by way of example, the communication may be implemented using other types of user equipment (UE) or wireless computing devices such as a mobile telephone, personal digital assistant (PDA), combination mobile telephone/PDA, handheld device, mobile unit, game device, messaging device, media player, or other suitable mobile communications devices.

By way of illustration, FIG. 2 shows example portable multifunction devices 202, including a tablet computer 204, a smart phone 206, and a laptop 208. Other types of portable multifunction devices may be used.

Some of the portable multifunction devices 202 may support wireless wide area network (WWAN) data communications services including Internet access. Examples of WWAN data communications services may include Evolution-Data Optimized or Evolution-Data only (EV-DO), Long Term Evolution (LTE), Evolution For Data and Voice (EV-DV), CDMA/1×RTT, GSM with General Packet Radio Service systems (GSM/GPRS), Enhanced Data Rates for Global Evolution (EDGE), High Speed Downlink Packet Access (HSDPA), High Speed Uplink Packet Access (HSUPA), and others. The user devices 202 may also provide wireless local area network (WLAN) data communications functionality in accordance with the Institute of Electrical and Electronics Engineers (IEEE) 802.xx series of protocols, such as the IEEE 802.11a/b/g/n series of standard protocols and variants (also referred to as “Wi-Fi”), the IEEE 802.16 series of standard protocols and variants (also referred to as “WiMAX”), the IEEE 802.20 series of standard protocols and variants, and others.

In some example embodiments, the portable multifunction devices 202 also may be arranged to perform data communications functionality in accordance with shorter range wireless networks, such as a wireless personal area network (PAN) offering Bluetooth® data communications services in accordance with the Bluetooth®. Special Interest Group (SIG) series of protocols, specifications, profiles, and so forth. Other examples of shorter range wireless networks may employ infrared (IR) techniques or near-field communication techniques and protocols, such as electromagnetic induction (EMI) techniques including passive or active radio-frequency identification (RFID) protocols and devices.

A portable multifunction device 202 may provide a variety of applications for allowing a user to accomplish one or more specific tasks using the well placement system 200. The portable multifunction device 202 may comprise various software programs such as system programs and applications to provide computing capabilities in accordance with the described embodiments. System programs may include, without limitation, an operating system (OS), device drivers, programming tools, utility programs, software libraries, application programming interfaces (APIs), and so forth. As is to be appreciated, the portable multifunction device 202 may include any suitable OS, such as a mobile OS (ANDROID, BLACKBERRY OS, iOS, SYMBIAN OS, WINDOWS PHONE, and so forth), a desktop OS (MAC OS X, LINUX, WINDOWS, GOOGLE CHROME OS, and so forth) or a television OS (GOOGLE TV, APPLE TV, or other Smart TV OS), for example.

In general, a software application may provide an interface to communicate information between the well placement system 200 and the user via portable multifunction devices 202. The software application may include or be implemented as executable computer program instructions stored on computer-readable storage media such as volatile or non-volatile memory capable of being retrieved and executed by a processor to provide operations for the portable multifunction device 202. The memory may also store various databases and/or other types of data structures (e.g., arrays, files, tables, records) for storing data for use by the processor and/or other elements of the user devices 202.

Referring still to FIG. 2, the well placement system 200 may include several computer servers. For example, the well placement system 200 may include one or more web servers 224, application servers 226, and notification servers 228. For convenience, only one web server 224, application server 226, and one notification server 228 are shown in FIG. 2, although it should be recognized that this disclosure is not so limited. The web server 224 may provide a graphical web user interface through which users of the system may interact with the well placement system 200. The web server 122 may accept requests, such as HTTP requests, from clients (such as web browsers) such as HTTP responses, along with optional data content, such as web pages (e.g., HTML documents) and linked objects (such as images, etc.).

The application server 226 may provide an alternate interface for users communicating with the well placement system 200. Such users may have software installed on their portable multifunction device 202 that allows them to communicate with the application server 226 via the network 232 using an Applications Programming Interface (API). Such software may be downloaded, for example, from the well placement system 200, or other software application provider, over the network to such user portable multifunction device 202. The software may also be installed on such portable multifunction device 202 by other means known in the art.

The notification server 228 may cause notifications, such as emails, text messages, smart phone notifications, phone calls, or other types of communications, to be sent to the portable multifunction device 202 via the network 232 and to track/store the notifications.

The servers 224, 226, 228 may comprise processors (such as CPUs, for example), memory units (such as RAM, ROM, for example), non-volatile storage systems (such as hard disk drive systems, for example). The servers 224, 226, 228 may utilize operating systems, such as Solaris, Linux, or Windows Server operating systems, for example.

Although FIG. 2 depicts a limited number of elements for purposes of illustration, it can be appreciated that the well placement system 200 may include more or fewer elements as well as other types of elements in accordance with the described embodiments. Elements of the well placement system 200 may include physical or logical entities for communicating information implemented as hardware components (computing devices, processors, logic devices, and so forth), executable computer program instructions (firmware, software) to be executed by various hardware components, or combination thereof, as desired for a given set of design parameters or performance constraints.

In one embodiment, the portable multifunction device 202 is used to provide information on existing wells and/or on a greenfield or brownfield for which a well placement is to be performed. This may be done by a single device or multiple devices working in tandem. The well placement system 200 may then perform computations for well placement, such as described herein, and transmit the resulting content 236 to the portable multifunction device.

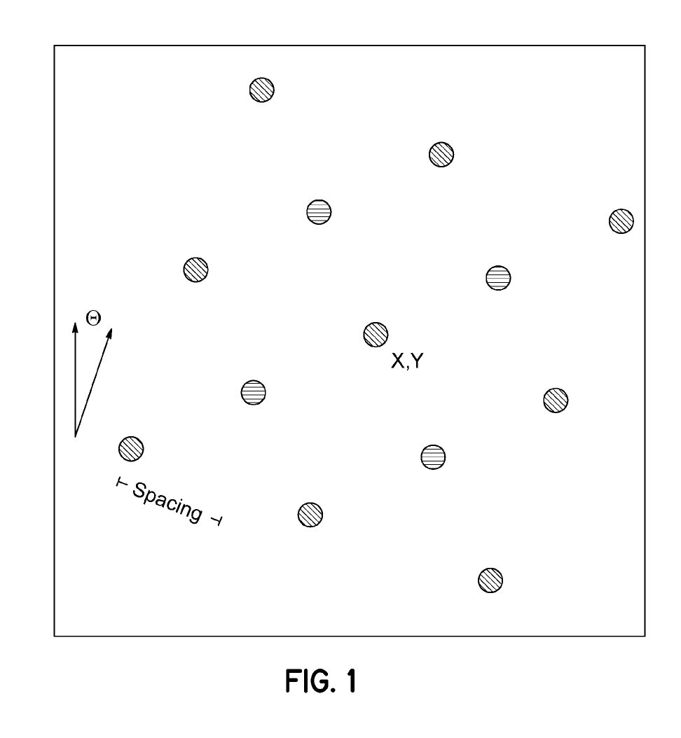

As noted above, FIG. 1 illustrates a pattern control vector for 5-spot pattern: location of one well (x,y), the well spacing, azimuth, and aspect ratio. These five control variables are sufficient to define the geometry of a pattern, and can be control variables in for example, linear downhill simplex optimization method. According to principles of the present invention, this optimization is extended by introducing an additional constraint, which determines the radius within which the system may decide to re-use an existing well, as either a producer or an injector, or convert P/I, instead of drilling a new well as per a geometrical pattern. This approach allows optimization of the well placement plan so that existing wells are used or recompleted while at the same time generating a reasonable geometrical pattern.

In summary, the present invention provides an automated framework which may answer questions such as: which N changes to the producer-injector waterflood system should be introduced (for the whole field or selected areal segment) in order to increase a stated objective function value (e.g., NPV)? In this case, each individual change involves drilling a new producer or injector (P or I event), or recompletion of a producer as an injector (P/I event.) Thus, introducing only one additional constraint which does not affect much total convergence time, generates much more practical well placement plans, which yield higher NPV. The NPV is increased because converting a producer to an injector is generally cheaper than drilling a new injector.

The principles of the present invention also address the challenge of designing patterns in the presence of reservoir heterogeneity, using streamline analysis.

Regular geometrical patterns, such as 5-spot (see FIG. 4), yield reasonably high sweep efficiency (and consequently good NPV) only on a reservoir with little or modest heterogeneity. If however, there is significant heterogeneity in the dynamic properties (brownfields), or the static properties (greenfields and brownfields) geometric patterns will be sub-optimal. For example, when there are disconnected geobodies which make “patchwork”, or in mature reservoirs there are many unswept areas, following a regular geometry doesn't bring much benefit, due to the heterogeneity manifested in both the static geologic properties and the dynamic fluid properties.

The present invention proposes to honor the topology of a secondary production pattern (e.g., 5 spot waterflood) while distorting the geometry of the pattern in response to underlying heterogeneities. Streamline simulation can be used to identify allocation factors for each producer-injector pair, which can then be used to guide the optimizer to discover the optimal distorted geometry of the pattern.

In one embodiment, the well placement system may use cloth simulation algorithms heavily employed in the game industry (Ozgen and Kallman, 2011). In the present application, each well pattern can be interpreted as a piece of “cloth”, consisting of several producers and injector, connected by springs, which can be adjusted. As a result, the pattern can be distorted to a level which improves local sweep efficiency without breaking topology. The resulting algorithm is very fast, but still allows an agile adjustment to a variety of realistic physical maps (streamlines in our case), without breaking topology of each pattern and the entire well placement plan.

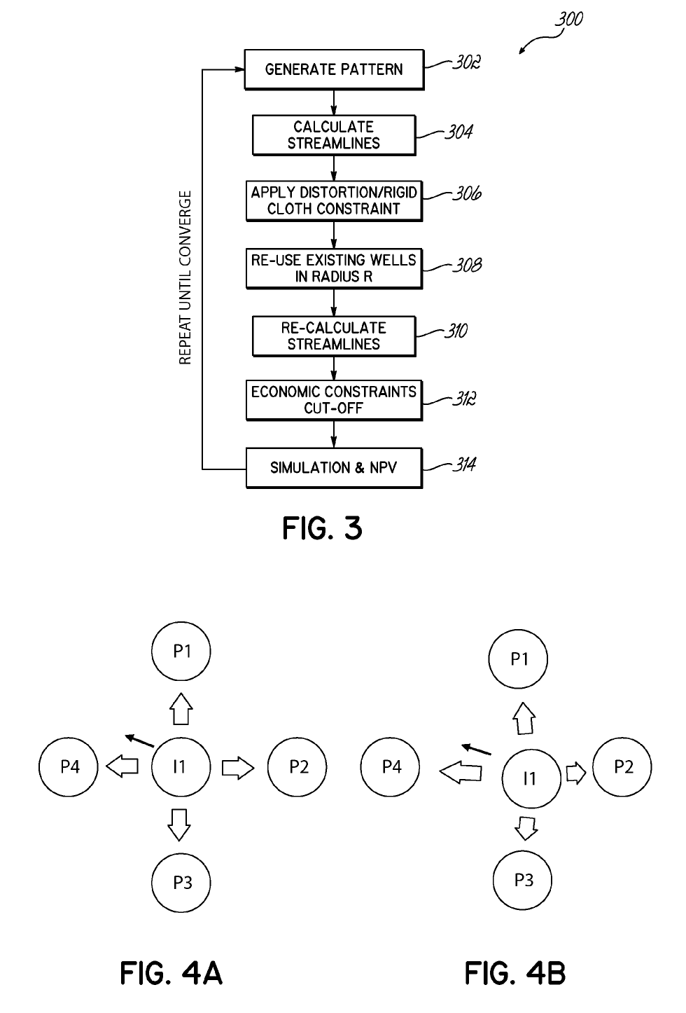

FIG. 3 illustrates the workflow for generating the well placement plan and its usage. For the process illustrated in this figure, we define operators as
G—generate pattern
R—apply radius constraint/re-use existing wells
˜—streamline calculator
D—apply distortion/cloth constraints
$—apply economical cut-offs
NPV—run full-field simulator and calculate objective function

With these descriptions, the workflow can be presented as follows:
1. Original/classical algorithm
   1.1. [G] [NPV] [$]—loop until converge
2. with added radius and streamlines
   2.1. [G] [R] [˜] [$] [NPV]—-loop until converge
3. with added distortion
   3.1. [G] [R] [˜] [D] [$] [NPV]—loop
   3.2. [G] [˜] [D] [R] [˜] [$] [NPV]—loop

The fullest version of the algorithm, 3.2, requires additional streamline calculation in each loop relative to 3.1, but as the streamline calculation is reasonably fast it can be a useful trade-off and will generally yield higher NPV with a modest increment in convergence time. FIG. 3 illustrates the 3.2 algorithm.

The present invention further contemplates the application of a streamline-driven distortion algorithm. Specifically, allocation factors in each producer-injector pair are used to drive the adjustment of local geometry to improve sweep efficiency, according to the following steps.

1) Define pattern as set of injector and several producers to which this injector's flood is allocated

2) Scan all patterns to calculate vector, defined as centers of mass for the pattern, where each producer has a weight as corresponding to the allocation factor (share of discounted total production.)

3) Rank patterns based on the vector's length, to produce ordered list of patterns that need most deformation, and cut-off those that require marginal change

4) Deform each pattern. Each deformation will move injector and each producer so that injector will now become the center of mass, calculated in step 2

5) This will improve sweep efficiency of those patterns ensuring a more balanced production distribution and water front propagation in each pattern.

6) Repeat for several iterations over all patterns until the maximum number of iterations or until convergence is achieved. Note that even a single iteration improves local sweep in those patterns and for the entire field in total, yielding higher NPV than regular geometrical patterns.

FIG. 4 illustrates the distortion thusly applied to a single 5-spot pattern. The thin resulting vector calculated in step 2 shows the computed center of mass related to the injector 11, and FIG. 4 illustrates that all five wells 11 and P1-P4 move accordingly so that new center of mass has the same position as the originally positioned injector I1. If some wells are existing, the algorithm will disallow movement of those wells, and movement will be applied only to new producers/injectors.

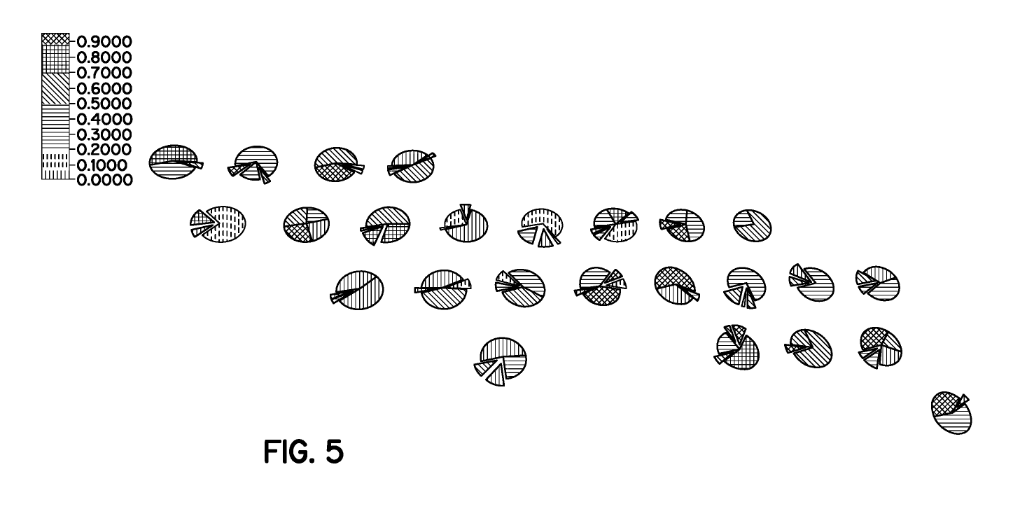

FIG. 5 illustrates a sample implementation of the present invention using commercial software available from the assignee hereof, on a chosen Brugge synthetic field which is widely used for history match and prediction benchmarking. A selected one of the Brugge realizations was used to setup do_nothing scenario which yields $5 bln NPV with 10% discount, for 20 years of simulation forecast. A $40 mln constraint was applied to new wells and £20 mln for recompletion across all scenarios as applicable. The software then implemented following scenarios:

Scenario 1. Regular 5-spot yields 120% comparing to do_nothing

Scenario 2: Regular 5-spot with re-using existing wells—producers, injectors, or P/I conversions 138%

Scenario 3: We modified scenario 2 by adding distortion for new injectors only (simplified version of algorithm 3.1), which yielded 145% compared to do_nothing.

Moreover, besides driving optimization, we noticed that such adjustment increments NPV for almost any well placement plan, hence it can also be used outside of optimization loop, e.g. when initial guess/pattern layout is generated.

FIG. 5 provides a streamlines visualization for combination of existing and proposed wells. It shows allocation factors and streamlines for particular timestamp (the algorithm summarizes those for entire prediction period as using a tracer simulator for streamlines. It has been found that several iterations are enough to define the trends in connectivity/heterogeneity). On the right bottom side, tracer particles can be seen, travelling from selected injector to connected producers.

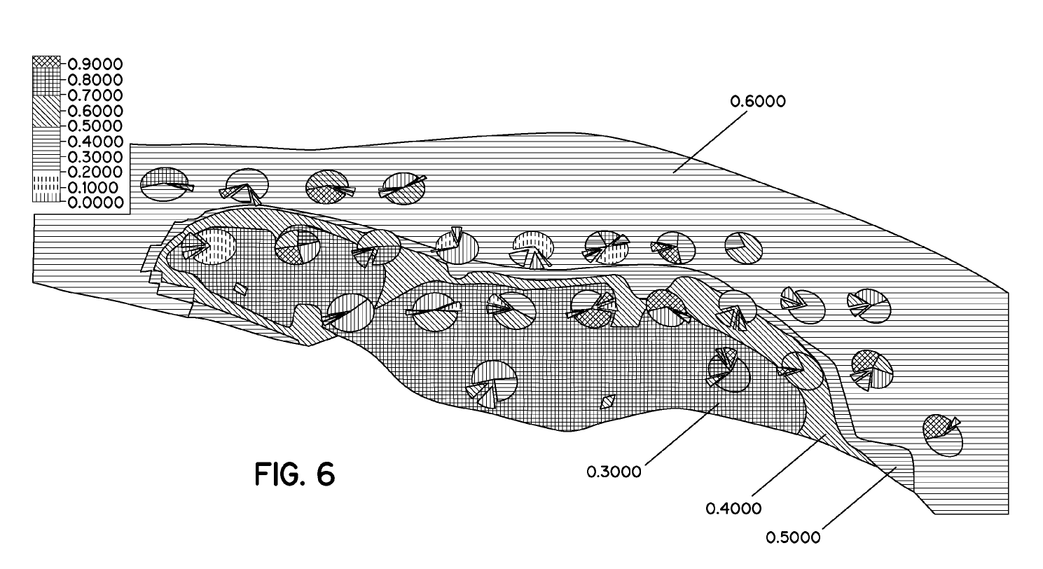

FIG. 6 provides a similar view as FIG. 5, now showing water saturation at the start of prediction.

It will be appreciated that the approach described above can be utilized in various applications as described in the workflow diagram.
Brownfield re-patterning optimization in Automated field development planning
Greenfield “adaptive” pattern design in Automated field development planning

As described herein, a software application may be executed on a laptop, desktop or portable multifunction device to allow a user to access and store content received from the well placement system. The application may also allow a user to provide user preferences to the well placement system. As is to be appreciated, the application may be structured in a number of ways, including as an application service to be implemented partially on the laptop, desktop or portable device and partially on the server, or entirely on the server or portable device.

In general, it will be apparent to one of ordinary skill in the art that at least some of the embodiments described herein may be implemented in many different embodiments of software, firmware, and/or hardware. The software and firmware code may be executed by a processor or any other similar computing device. The software code or specialized control hardware that may be used to implement embodiments is not limiting. For example, embodiments described herein may be implemented in computer software using any suitable computer software language type, using, for example, conventional or object-oriented techniques. Such software may be stored on any type of suitable computer-readable medium or media, such as, for example, a magnetic or optical storage medium. The operation and behavior of the embodiments may be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes associated with the present embodiments may be executed by programmable equipment, such as computers or computer systems and/or processors. Software that may cause programmable equipment to execute processes may be stored in any storage device, such as, for example, a computer system (nonvolatile) memory, an optical disk, magnetic tape, or magnetic disk. Furthermore, at least some of the processes may be programmed when the computer system is manufactured or stored on various types of computer-readable media.

It can also be appreciated that certain process aspects described herein may be performed using instructions stored on a computer-readable medium or media that direct a computer system to perform the process steps. A computer-readable medium may include, for example, memory devices such as diskettes, compact discs (CDs), digital versatile discs (DVDs), optical disk drives, or hard disk drives. A computer-readable medium may also include memory storage that is physical, virtual, permanent, temporary, semipermanent, and/or sem itemporary.

A “computer,” “computer system,” “host,” “server,” or “processor” may be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein may include memory for storing certain software modules used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable media.

In various embodiments disclosed herein, a single component may be replaced by multiple components and multiple components may be replaced by a single component to perform a given function or functions. Except where such substitution would not be operative, such substitution is within the intended scope of the embodiments. Any servers described herein, for example, may be replaced by a “server farm” or other grouping of networked servers (such as server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand and/or providing backup contingency in the event of component failure or reduction in operability.

The computer systems may comprise one or more processors in communication with memory (e.g., RAM or ROM) via one or more data buses. The data buses may carry electrical signals between the processor(s) and the memory. The processor and the memory may comprise electrical circuits that conduct electrical current. Charge states of various components of the circuits, such as solid state transistors of the processor(s) and/or memory circuit(s), may change during operation of the circuits.

While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

What is claimed is:

1. A well placement management system, comprising:
a. a database storing well parameters or plurality of wells including one or both of existing and prospective wells, the wells being one or both of producers and injectors; and
b. a processor connected to the database for retrieving well parameters and computing therefrom a simulation of productivity of a plurality of wells based upon their placement and other parameters;
c. wherein the processor implements a repeating streamline calculation utilizing a constraint to evaluate the productivity of said plurality of wells, the streamline calculation comprising applying a distortion to one or more well parameters and calculating resulting streamlines and the constraint to determine parameter changes that improve the constraint;
d. wherein the repeated streamline calculation is performed to find an apparent optimal set of well parameters.

2. A well placement management system according to one or more of the inventive principles as shown and described herein.

3. A method of using a well placement management system, the method comprising:
a. storing well parameters for one or both of existing and prospective wells, the wells being one or both of producers and injectors;
b. retrieving well parameters and computing therefrom a simulation of productivity of a plurality of wells based upon their placement and other parameters; and
c. repeatedly performing a streamline calculation utilizing a constraint to evaluate the productivity of said plurality of wells, the streamline calculation comprising applying a distortion to one or more well parameters and calculating resulting streamlines and the constraint to determine parameter changes that improve the constraint;
d. wherein the repeated streamline calculation is performed to find an apparent optimal set of well parameters.

4. A method of using a well placement management system, the method according to one or more of the inventive principles as shown and described herein.

5. A program product implementing a well placement management system, the program product comprising:
a. executable instructions for storing well parameters for one or both of existing and prospective wells, the wells being one or both of producers and injectors;
b. executable instructions for retrieving well parameters and computing therefrom a simulation of productivity of a plurality of wells based upon their placement and other parameters; and
c. executable instructions for repeatedly performing a streamline calculation utilizing a constraint to evaluate the productivity of said plurality of wells, the streamline calculation comprising applying a distortion to one or more well parameters and calculating resulting streamlines and the constraint to determine parameter changes that improve the constraint, wherein the repeated streamline calculation is performed to find an apparent optimal set of well parameters; and
d. a tangible medium bearing the executable instructions.

6. A component of a well placement management system according to one or more of the inventive principles as shown and described herein.

7. A method of using a component of a well placement management system, the method being substantially as shown and described herein.

8. A method of using a component of a well placement management system, the method according to one or more of the inventive principles as shown and described herein.
